(19) United States
(12) Patent Application Publication
(10) Pub. No.: US 2001/0023928 A1
(43) Pub. Date: Sep. 27, 2001

(54) Electrohydraulic valve actuator

(76) Inventors: David Kentfiled Green, Banchory (GB); Jill Merrilees, Aberdeen (GB)

Correspondence Address: Richard T. Redano, Duane, Morris & Heckscher LLP, Suite 500, One Greenway Plaza,, Houston, TX, 77046, US

(21) Appl. No.: 09/745,145

(22) Filed: Dec. 20, 2000

Related U.S. Application Data
(60) Provisional application No. 60/174,734, filed on Jan. 6, 2000.

(51) Int. Cl. F16K 31/122

(52) U.S. Cl. 251/62; 251/129.04

(57) ABSTRACT

A valve actuator for surface and sub-sea applications is disclosed. The valve actuator stem is hydraulically actuated by a piston attached to it. A fluid filled reservoir with a pump which preferably operates on 24 volts D.C. is included in the actuator housing. The pump draws fluid from the reservoir and pumps it against the piston. A solenoid valve allows bypass from beneath the piston back to the reservoir for fail safe operation in the event of power loss. Positional sensors on the actuator stems trigger the operation of the pump. As long as 24 volts D.C. power is available the pump may selectively run if the actuator stem position changes for any reason.

### CROSS REFERENCE TO RELATED APPLICATION

This nonprovisional U.S. application claims the benefit of provisional application No. 60/174,734, filed on Jan. 6, 2000.

### FIELD OF THE INVENTION

The field of this invention is remotely operated valve actuators.

### BACKGROUND OF THE INVENTION

Valve actuators in the oil field have traditionally been hydraulically operated. They obtain a fail safe position by removal of the applied hydraulic pressure at which time a return spring operates on the valve operator stem to put the valve to which the valve actuator stem is connected into its fail safe position. The underlying valve could fail open or fail close depending on the needs of the system in which it is installed.

More recently operators have expressed the desire to get away from hydraulic systems for several reasons. The primary reason is the potential for leaks and the safety and pollution hazards that are associated with such leaks of hydraulic fluid. Another disadvantage has been the need to provide the hydraulic pressure which in some location necessitated the provision of a power unit for operation of various valve actuators and other equipment.

While actual stroking of the valve actuator stem is done hydraulically, the necessity of running hydraulic lines for great distances in certain applications made such mode of operation a disadvantage. Accordingly one of the objects of the present invention is to operate an actuator with a feed supply of electrical power yet have the workings of the actuator itself operate hydraulically. Another object of the present invention is to provide power in a mode where it is intrinsically safe so that it can be safely operated in environments which would otherwise require explosion proof fittings. Another object of the present invention is to configure the actuator so that it can be easily used on the surface or subsea. Another objective of the present invention is to provide a compact design for the actuator which, in the preferred embodiment, incorporates the hydraulic power system internally of the actuator housing. These and other advantages of the apparatus of the present invention will become apparent to those skilled in the art from a review of the detailed description of the preferred embodiment below.

### SUMMARY OF THE INVENTION

A valve actuator for surface and sub-sea applications is disclosed. The valve actuator stem is hydraulically actuated by a piston attached to it. A fluid filled reservoir with a pump which preferably operates on 24 volts D.C. is included in the actuator housing. The pump draws fluid from the reservoir and pumps it against the piston. A solenoid valve allows bypass from beneath the piston back to the reservoir for fail safe operation in the event of power loss. Positional sensors on the actuator stems trigger the operation of the pump. As long as 24 volts D.C. power is available the pump may selectively run if the actuator stem position changes for any reason.

### BRIEF DESCRIPTION OF THE DRAWINGS

FIG. 1 is a sectional elevational view of the actuator of the present invention in the normal operating position.

FIG. 2 is the view of FIG. 1 with the valve actuator in the fail safe position.

### DETAILED DESCRIPTION OF THE PREFERRED EMBODIMENT

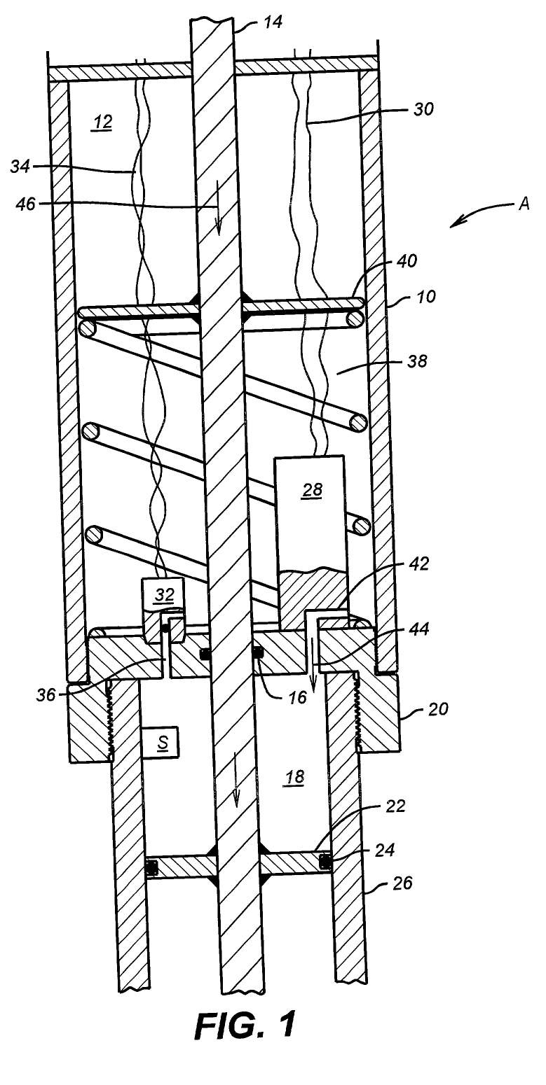

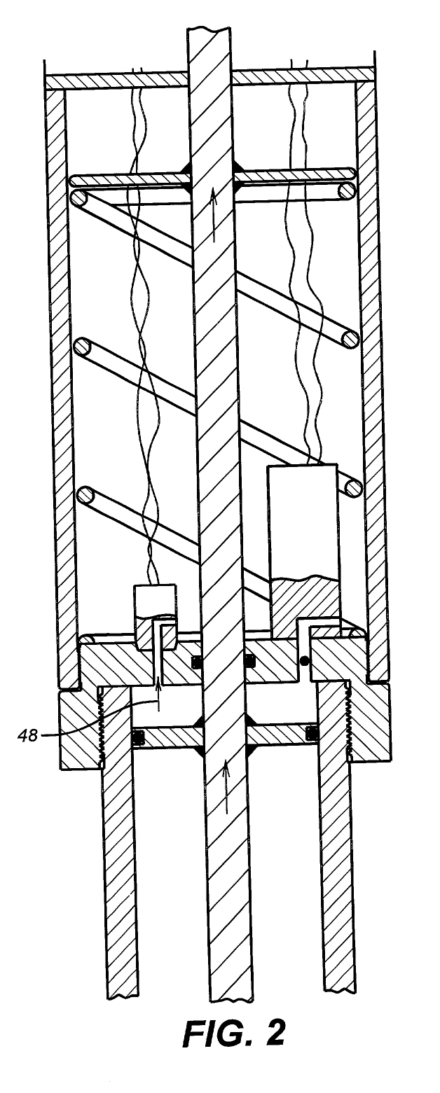

Referring to FIG. 1 the actuator A has a housing 10 defining a chamber 12 inside. An actuator shaft 14 is sealingly mounted in the housing 10 for reciprocating motion between the position shown in FIGS. 1 and 2. A seal 16 separates chamber 12 from chamber 18. Chamber 18 is defined between end cap 20 and piston 22. Seal 24 seals between the piston 22 and sleeve 26 thus defining chamber 18.

Mounted in chamber 12 is a motor driven pump 28 which is electrically powered via lines 30 and preferably runs on 24 volts D.C. A solenoid valve 32 is electrically powered through lines 34. Solenoid 32 preferably also runs on 24 volts D.C. thus making the assembly intrinsically safe. Solenoid 32 is illustrated schematically in FIGS. 1 and 2. It has a passage 36 extending from chamber 18 to chamber 12. When solenoid 32 is electrically energized passage 36 is closed. This is shown in FIG. 1. When the solenoid 32 is de-energized as shown in FIG. 2 passage 36 is open.

Located inside housing 10 is a return spring 38. Return spring 38 bears on one end at end cap 20 and at the other end on plate 40. Plate 40 is connected to actuator shaft 14.

All of the parts of the actuator A of the present invention now having been described, its operation will be reviewed in greater detail. To put the actuator in the normal operating position of FIG. 1 power is supplied through lines 30 and 34 to the pump 28 and solenoid 32 respectively. The result of this is that pump 28 draws hydraulic fluid from chamber 12 and pumps it into chamber 18 through passage 42. The hydraulic flow is represented by arrow 44. Hydraulic flow into chamber 18 displaces piston 22 which in turn takes with it actuator shaft 14. The movement of actuator shaft 14 is given by arrow 46. Movement of the actuator shaft 14 in the direction of arrow 46 brings down plate 40 and compresses spring 38. At this time passage 36 is closed because the solenoid 32 is energized. Operation of pump 28 continues until sensor S shown in FIG. 1 senses a mark on actuator shaft 14 to indicate the full stroking of the actuator 14. At that point pump 28 stops running while solenoid 32 remains energized. With pump 28 not operating there is no back flow through passage 44 back to chamber 12. In the event there is some leakage from chamber 18 back to chamber 12 through passage 44 through the pump 28 the sensor S will detect movement of the shaft 14 and actuate the pump 28 to restart until the travel limit is again sensed.

In the event of a power interruption the solenoid 32 is de-energized opening passage 36 between chamber 18 and chamber 12. Because chamber 18 has higher pressure flow will be in the direction of arrow 48 in FIG. 2. The volume of chamber 18 decreases mainly as a result of the stored energy in spring 38 acting on plate 40. This stored energy is released as passage 36 is opened due to the de-energizing of solenoid 32 in the event of a power outage.

It should be noted that in the preferred embodiment the pump 28 and solenoid 32 are inside the actuator housing 10. The lines 30 and 34 sealingly extend through the top plate of housing 10. Those skilled in art will also appreciate alternative configuration are within the scope of the invention. For example the solenoid 32 and pump 28 can be mounted externally to the housing 10 with the flow paths 42 and 36 configured externally of the housing 10 with additional taps into chambers 12 and 18 as needed. The type of pump 28 used can be altered without departing from the spirit of the invention. Different power levels can be supplied depending on the application. Different style of equalization valves can be used for solenoid 32 without departing from the spirit of the invention.

Redundant backups can also be provided for the pump 28 or the solenoid 32 without departing from the spirit of the invention. The actuator A can be mounted in surface applications or subsea. Putting the components such as the pump 28 and the solenoid 32 inside the housing 10 also protects them from physical damage during installation or operation as well as protecting them from hostile effects of the surrounding environment whether on surface or a subsea application. The design is simple and reliable and allows for ready replacement of complicated hydraulic systems. The pump 28 is fairly economical such that it can be provided for each individual actuator A while making the overall installation more economical then a central hydraulic power supply for a multitude of valves. In many locations the availability of local hydraulic systems is not present. Additionally installation of such a system is much quicker than a purely hydraulic system.

The previous description is intended to be illustrative of the preferred embodiment and the present invention encompasses not only the disclosed preferred embodiment but those variants which those of ordinary skill in art would readily ascertain from a review of the above description of the preferred embodiment.

We claim:

1. A valve actuator for selective positioning of a valve stem, comprising:
a housing surrounding the stem, at least in part;
a piston mounted to the stem;
a fluid pressure generation source mounted to said housing to develop pressure within said housing against said piston for selective movement of said shaft.

2. The actuator of claim 1, wherein:
said fluid pressure generation source comprises an electrically driven pump.

3. The actuator of claim 2, wherein:
said pump is provided power in an intrinsically safe manner.

4. The actuator of claim 1, wherein:
said fluid pressure generation source is mounted inside said housing.

5. The actuator of claim 1, wherein:
said fluid pressure generation source is mounted adjacent the outside of said housing.

6. The actuator of claim 2, further comprising:
a sealed variable volume cavity in said housing, a part of which is defined by said piston.

7. The actuator of claim 6, wherein:
said pump comprises a discharge connection in fluid communication with said cavity.

8. The actuator of claim 7, further comprising:
a fluid reservoir in said housing:
said pump comprising an inlet connection in flow communication therewith.

9. The actuator of claim 6, wherein:
said pump is mounted in fluid communication with said cavity for selective displacement of said piston.

10. The actuator of claim 9, further comprising:
a vent valve selectively allowing and preventing fluid communication between said cavity and a lower pressure portion of said housing.

11. The actuator of claim 10, wherein:
said valve is electrically operated.

12. The actuator of claim 11, wherein:
said valve is provided an intrinsically safe electrical source.

13. The actuator of claim 9, wherein:
said housing comprises a fluid reservoir;
said pump comprises an inlet connection to said reservoir and an outlet connection to said cavity.

14. The actuator of claim 6, further comprising:
a position sensor to detect the position of the stem;
said sensor operably connected to said pump for operation thereof to adjust the position of the stem to a desired position in the event of leakage of fluid from said cavity.

15. The actuator of claim 6, further comprising:
a return spring operably connected to the shaft to bias it in an opposite direction from the effect of pressure in said cavity developed by said pump;
a low pressure fluid reservoir in said housing which is connected to an inlet of said pump;
a vent valve to selectively allow communication between said cavity and said reservoir.

16. The actuator of claim 15, wherein:
said valve is electrically powered.

17. The actuator of claim 15, wherein:
said valve is mounted inside said housing.

18. The actuator of claim 16, wherein:
said valve allows communication between said cavity and said reservoir upon electrical failure of power to said valve.

19. The actuator of claim 16, wherein:
said valve is provided an intrinsically safe power source.

20. The actuator of claim 15, wherein:
said pump and said valve are disposed in said reservoir inside said return spring.
